(19) United States
(12) Patent Application Publication
(10) Pub. No.: US 2015/0234750 A1
(43) Pub. Date: Aug. 20, 2015

(54) METHOD AND APPARATUS FOR ADDRESSING A MEMORY CONTAINING DIFFERENT BIT-LENGTH FIELD VARIABLES

(71) Applicant: ASPEED Technology Inc., Hsinchu City (TW)

(72) Inventors: Chung-Yen LU, Hsinchu City (TW); Hung-Ju HUANG, Hsinchu City (TW)

(73) Assignee: ASPEED Technology Inc., Hsinchu City (TW)

(21) Appl. No.: 14/182,938

(22) Filed: Feb. 18, 2014

(51) Int. Cl. G06F 12/14; H04L 9/30

(52) U.S. Cl. CPC G06F 12/1408; H04L 9/3066; G06F 2212/1052; H04L 2209/24

(57) ABSTRACT

A method of accessing a desired memory location applied in a cipher processing apparatus is disclosed. The cipher processing apparatus comprises a plurality of registers and a register storage. The method comprises the steps of: reading a cipher instruction comprising an opcode field and an operand specifier field; reading a base address from one of the plurality of registers according to a register-id sub-field; respectively reading a bit length and an index value from the register storage and an index sub-field; determining the desired memory location according to the base address, the bit length and the index value; and, accessing the desired memory location to obtain a desired field variable. Here, the operand specifier field comprises the register-id sub-field and the index sub-field.

### BACKGROUND OF THE INVENTION

1. Field of the Invention

The invention relates to digital data processors, and more particularly, to a method and apparatus for addressing a memory containing different bit-length field variables.

2. Description of the Related Art

Elliptic Curve Cryptography (ECC) is a public key cryptography. In public key cryptography, each user or the device taking part in the communication generally have a pair of keys, a public key and a private key, and a set of operations associated with the keys to do the cryptographic operations. Only the particular user knows the private key whereas the public key is distributed to all users taking part in the communication. Some public key algorithm may require a set of predefined constants to be known by all the devices taking part in the communication. Domain parameters' in ECC is an example of such constants. Public key cryptography, unlike private key cryptography, does not require any shared secret between the communicating parties but it is much slower than the private key cryptography.

The mathematical operation of ECC is defined over the elliptic curve y²=x³+ax+b, where 4a³+27b²≠0. Each choice of a and b gives a different elliptic curve. All points (x, y) which satisfies the above equation plus a point at infinity lie on the elliptic curve. The public key is a point in the curve and the private key is a random number. The public key is obtained by multiplying the private key with the generator point G in the curve. The generator point G, the curve parameters ‘a’ and ‘b’, together with few more constants constitutes the domain parameter of ECC. One main advantage of ECC is its small key size. A 160-bit key in ECC is considered to be as secured as 1024-bit key in RSA.

In point multiplication, a point P on the elliptic curve is multiplied by a scalar k using an elliptic curve equation to obtain another point Q on the same elliptic curve, i.e., kP=Q. Point multiplication is achieved by two basic elliptic curve operations, including point addition and point doubling. Point addition is the addition of two points J and K on an elliptic curve to obtain another point L on the same elliptic curve, i.e., L=J+K. Point doubling is the addition of a point J on the elliptic curve to itself to obtain another point L on the same elliptic curve, i.e. L=2J.

The elliptic curve operations defined above are over real numbers. Operations over the real numbers are slow and inaccurate due to round-off error. Cryptographic operations need to be faster and accurate. To make operations on elliptic curve accurate and more efficient, the curve cryptography is defined over two finite fields: prime field Fp and binary field F₂^{m}. The finite field is chosen with finitely large number of points suitable for cryptographic operations. In the event that that the field Fp uses the numbers from 0 to (p˜1), computations end by taking the remainder on division by p. An elliptic curve with the underlying field of Fp can form by choosing the variables a and b within the field of Fp. The elliptic curve includes all points (x,y) which satisfy the elliptic curve equation modulo p (where x and y are numbers in Fp).

The operations discussed above are defined on affine coordinate system. Affine coordinate system is the normal coordinate system that we are familiar with in which each point in the coordinate system is represented by the vector (x, y). It has disadvantages in performing point addition and doubling. The vector (x, y) in affine coordinates can be represented by the triplet (X,Y,Z), which is called the projective coordinates. The relationship between (x, y) and (X,Y,Z) is as follows: (X,Y,Z)=(λ^{c}x, λ^{d}x, λ), (x, y)=(X/Z^{c}, Y/Z^{d}), where λ≠0. There are a number of types of coordinates when c, d are set different values, such as Jacobian, Chudnovsky-Jacobian, Lopez-Dahab projective coordinate systems. The use of projective coordinates can avoid field inversion operations.

To use ECC, all parties must agree on all the elements defining the elliptic curve, i.e., the domain parameters. The field is defined by p in the prime case and the pair of m and f in the binary case. The elliptic curve is defined by the constants a and b used in its defining equation and the cyclic subgroup is defined by a base point G. For cryptographic application the order of G, that is the smallest non-negative number n such that nG=∞, is normally prime. In cryptographic applications, this number h, called the cofactor, must be small (h<=4). In sum, in the prime case the domain parameters are (p, a, b, G, n, h) and in the binary case they are (m, f, a, b, G, n, h). The generation of domain parameters is not usually done by each participant since this involves counting the number of points on a curve which is time-consuming and troublesome to implement. As a result several standard bodies (such as NIST) published domain parameters of elliptic curves for several common field sizes.

FIG. 1 shows elements of a prime field elliptic curve cryptography (EC) processor according to prior art. U.S. Pat. No. 8,358,779 discloses an EC processor 104 including a prime field circuit 108, a curve operation processor 110, and an interface 112. Prime field circuit 108 includes a memory 114 to store data and an arithmetic logic unit (ALU) circuit 116 to perform prime field operations upon the data, as described below. ALU circuit 116 includes a field addition circuit 118 configured to perform field addition and field subtraction upon the data, and a field multiplication circuit 120 configured to perform field multiplication upon the data. In some embodiments, memory 114 includes a 16×256-bit dual-port synchronous register file constructed as 16 field registers and a 256-bit key register. The register file is used to store intermediate results from elliptic curve operations. The key register is used for point multiplication.

Curve operation processor 110 includes an instruction memory 122 to store instructions, a stack register 124, a program counter 126, and a controller 128 to execute the instructions stored in instruction memory 122. The instructions include instructions for performing curve operations upon the data. The curve operations include point addition, point doubling, point multiplication, and the like. The prior art did not disclose how to manage the EC point variables and field variables in memory. In fact, there are many different bit-length standards, so the memory needs to be configured to cooperate with these standards.

A general cipher processor with a memory that is configured to store different bit-length field variables is needed. Thus, there is a need for an addressing method for a single memory allocation, a general cipher processor and a general cipher instruction set to perform cipher operations suitable for different projective coordinates, different finite fields and different standards.

### SUMMARY OF THE INVENTION

In view of the above-mentioned problems, an object of the invention is to provide a method of accessing a desired memory location that stores different bit-length field variables to perform cipher operations, which is suitable for different projective coordinates, different finite fields and different standards.

One embodiment of the invention provides a method of accessing a desired memory location applied in a cipher processing apparatus. The method comprises the steps of: reading a cipher instruction comprising an opcode field and an operand specifier field; reading a base address from one of the plurality of registers according to a register-id sub-field; respectively reading a bit length and an index value from the register storage and an index sub-field; determining the desired memory location according to the base address, the bit length and the index value; and, accessing the desired memory location to obtain a desired field variable. Here, the operand specifier field comprises the register-id sub-field and the index sub-field.

Another embodiment of the invention provides a machine-readable medium having stored thereon cipher instructions. When the cipher instructions are executed by a cipher processor having a plurality of working registers, they cause the cipher processor to implement the steps comprising: decoding one cipher instruction comprising an opcode field and an operand specifier field; reading a base address from one of the plurality of working registers specified by a register-id sub-field; respectively reading a bit length and an index value from a register storage and an index sub-field; determining a field variable address according to the base address, the bit length and the index value; reading a desired field variable from an external memory device according to the field variable address; and, performing an operation specified by the opcode field on the desired field variable. Here, the operand specifier field comprises the register-id sub-field and the index sub-field.

Another embodiment of the invention provides a cipher processing apparatus. The cipher processing apparatus comprises a field variable memory, a register storage, a memory device and a cipher processor. The field variable memory stores a plurality of field variables. The register storage stores a bit length of the plurality of field variables. The memory device stores cipher instructions. The cipher processor coupled between the instruction memory and the field variable memory comprises an instruction decoder, a plurality of working registers and an execution unit. The instruction decoder decodes the cipher instructions, each including an opcode field and an operand specifier field. The operand specifier field comprises a register-id sub-field and an index sub-field. The execution unit receives a decoded instruction from the instruction decoder, reads a desired field variable from the field variable memory according to a field variable address and performs an operation specified by the opcode field on the desired field variable. The execution unit obtains the field variable address according to a base address, the index sub-field and the bit length. The register-id sub-field identifies a selected working register containing the base address.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows elements of a prime field elliptic curve cryptography (EC) processor according to prior art.

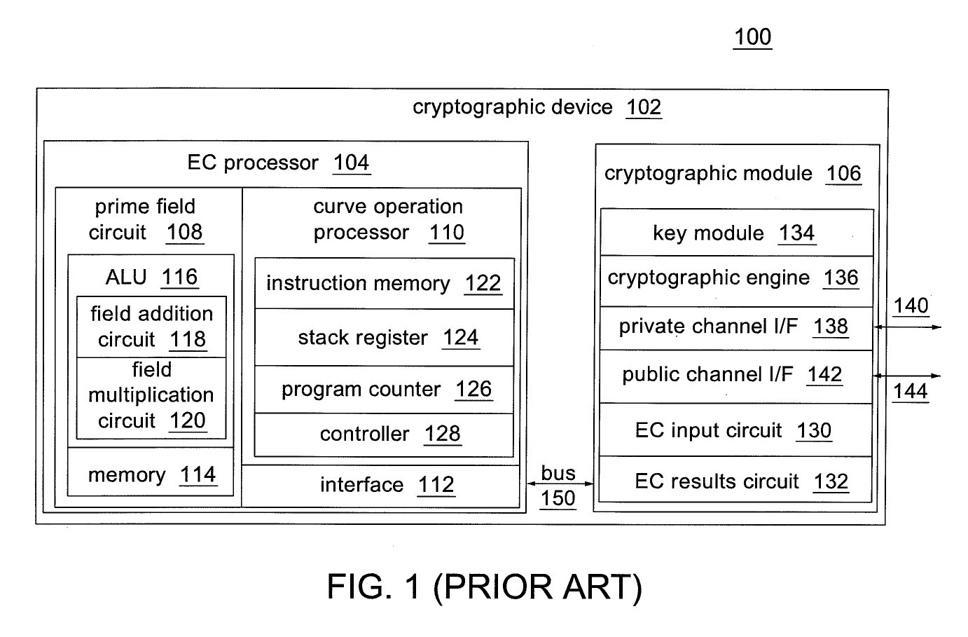

FIG. 2A is a schematic diagram of EC processing apparatus according to an embodiment of the invention.

FIG. 2B is a schematic diagram of EC processing apparatus according to another embodiment of the invention.

FIG. 3 is an example shows the relationship among the field variable memory 220, the working registers (213a, 213b) and the parameter bytesPerfieldvariable.

FIG. 4 is an exemplary EC instruction set according to an embodiment of the invention.

FIG. 5 is an exemplary EC instruction decoded in the EC processor.

### DETAILED DESCRIPTION OF THE INVENTION

As used herein and in the claims, the term “a,” “an,” “the” and similar terms used in the context of the present invention (especially in the context of the claims) are to be construed to cover both the singular and plural unless otherwise indicated herein or clearly contradicted by the context.

A feature of the invention is to perform cipher operations for different bit-length operands, different projective coordinates and different curves using a single cipher processor, a single memory and a single cipher instruction set.

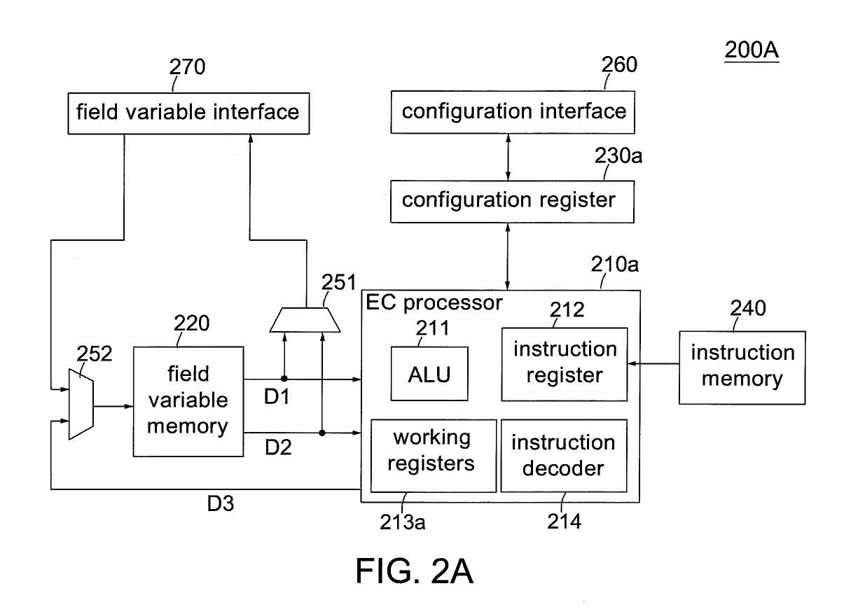

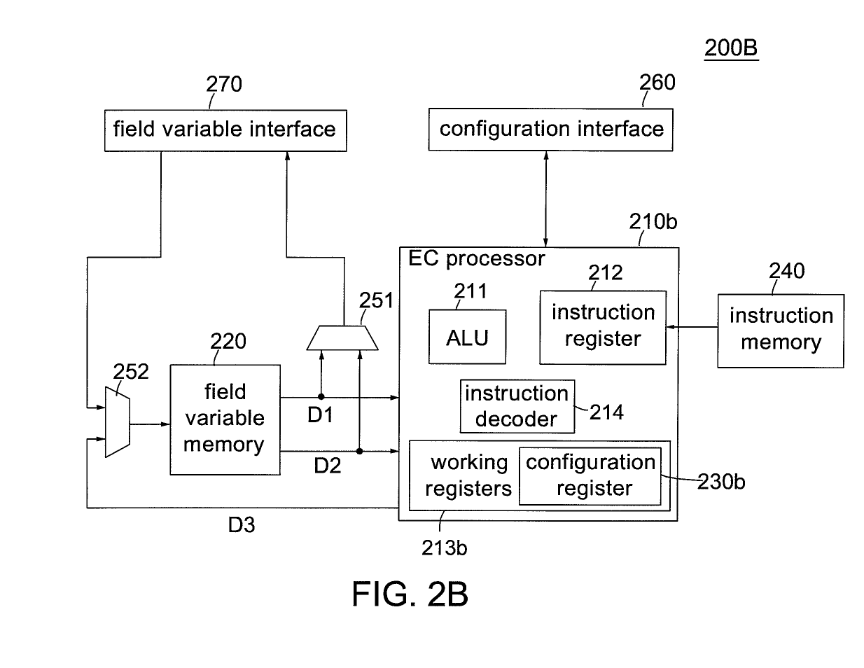

FIG. 2A is a schematic diagram of EC processing apparatus according to an embodiment of the invention. Referring to FIG. 2A, an EC processing apparatus 200A of the invention includes an EC processor 210a, a field variable memory 220, a configuration register 230a, an instruction memory 240, two multiplexers 251 and 252, a configuration interface 260 and a field variable interface 270. The EC processor 210a at least includes an arithmetic logic unit (ALU) 211, an instruction register 212, a plurality of working registers 213a and an instruction decoder 214. Here, the field variable memory 220 is implemented by static random access memory (SRAM) and the instruction memory 240 is implemented by read-only memory (ROM).

Referring to FIG. 2A, the instruction memory 240 stores a plurality of instructions while the field variable memory 220 is used to store field variables of EC points and temporary field variables (will be described below). The configuration register 230 is used to store a bit length of the field variables and the temporary field variables. The configuration interface 260 controls setting and reading the content of the configuration register 230 while the field variable interface 270 controls writing and reading the content of the field variable memory 220 via two multiplexers 251 and 252. Each encoded instruction is fetched from the instruction memory 240 and temporarily stored in the instruction register 212. Next, the instruction decoder 214 decodes the encoded instruction in the instruction register 212 into a decoded instruction. According to the operation code (opcode) and at least one operand specifier contained in the decoded instruction (its format will be described below), the ALU 211 accesses the working registers 213a and the configuration register 230a to read at least one of data D1 and D2 from the field variable memory 220, performs a corresponding operation on at least one of the data D1 and D2 and finally writes a resulting data D3 back to the field variable memory 220.

FIG. 2B is a schematic diagram of EC processing apparatus according to another embodiment of the invention. Comparing FIGS. 2A and 2B, they have the similar circuit structure except that the configuration register 230a is coupled between the EC processor 210a and the configuration interface 260 in FIG. 2A while the configuration register 230b is integrated into the working registers 213b in FIG. 2B. In one embodiment, the configuration register 230b is part of the working registers 213b. Accordingly, during operation, the configuration register 230a is set via the configuration interface 260 from the exterior of the EC processing apparatus 200A while the configuration register 230b is set via program codes.

An EC point may contain several field variables depending on different coordinate representations. For example, an EC point contains two field variables (such as (x, y)) if it is expressed by an affine representation; an EC point contains three field variables (such as (X, Y, Z)) if it is expressed by a Jacobian representation; an EC point contains five field variables (such as (X, Y, Z, Z², Z³)) if it is expressed by a Chudnovsky-Jacobian representation.

Point doubling and point addition are normally applied in point multiplication. Suppose that P=(X₁, Y₁, Z₁) and Q=(X₃, Y₃, Z₃) in Jacobian coordinates. One algorithm of point doubling in Jacobian coordinates is illustrated as follows. Formulas for point doubling in Jacobian coordinates are: 2(X₁:Y₁:Z₁)=(X₃:Y₃:Z₃), where T₀=4X₁*Y₁², T₁=8Y₁⁴, T₂=3(X₁−Z₁²)*(X₁+Z₁²), T₃=−2T₀+T₂², X₃=T₃, Y₃=T₂*(T₀−T₃)−T₁, Z₃=2Y₁*Z₁. Thus, there are six field variables (X₁, Y₁, Z₁, X₃, Y₃, Z₃) and four temporary field variables (T₀, T₁, T₂, T₃) used in the above point doubling operation. In the same manner, there are different numbers of field variables and temporary field variables used in point addition as well as in different coordinates.

Based on the above two paragraphs, an addressing equation is provided as follows to address the memory space of the field variable memory 220:

field variable address=base address+index*bytesPerfieldvariable (1)

=R[regid]+index*bytesPerfieldvariable (2)

Here, the parameter regid identifies a specific working register R[regid] (213a, 213b) containing a corresponding base address and the parameter bytesPerfieldvariable denotes the bit length contained in the configuration register (230a, 230b). The addressing equation is used to access the field variable memory 220 for a specified field variable. Various elliptic curves need field variables with various bit lengths for performing field arithmetic. It is noted that because this is a byte addressing architecture, the parameter bytesPerfieldvariable is used to calculate the byte address of each field variable. Since the parameter bytesPerfieldvariable varies according to various EC standards, the field variable memory 220 is scalable for various standards.

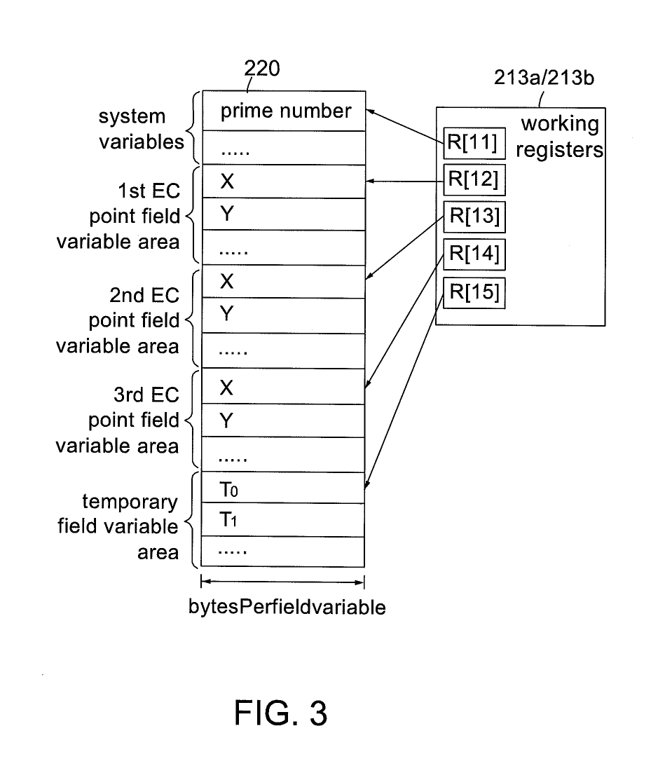

FIG. 3 is an example shows the relationship among the field variable memory 220, the working registers (213a, 213b) and the parameter bytesPerfieldvariable according to an embodiment of the invention. Referring to FIG. 3, each field variable in the field variable memory 220 has a bit length of bytesPerfieldvariable. Each of the first EC point field variable area, the second EC point field variable area and the third EC point field variable area stores the same number of field variables, e.g., three field variables in Jacobian coordinates. As to the temporary field variable area, the number of the temporary field variable varies according to different point arithmetic and different coordinates. The sizes of the EC point field variable areas and the temporary field variable area are extendable; besides, the base addresses of the EC point field variable areas and the temporary field variable area can be arbitrarily designated. Two examples are given as follow. First, let working register R[12] denote the base address of an EC point P and X denote the first field variable, i.e., index=0 according to the above addressing equation; thus, the field variable address of P.X is R[12]. Second, let working register R[13] denote the base address of an EC point Q and Y denote the second field variable, i.e., index=1 according to the above addressing equation; thus, the field variable address of Q.Y is (R[13]+bytesPerfieldvariable).

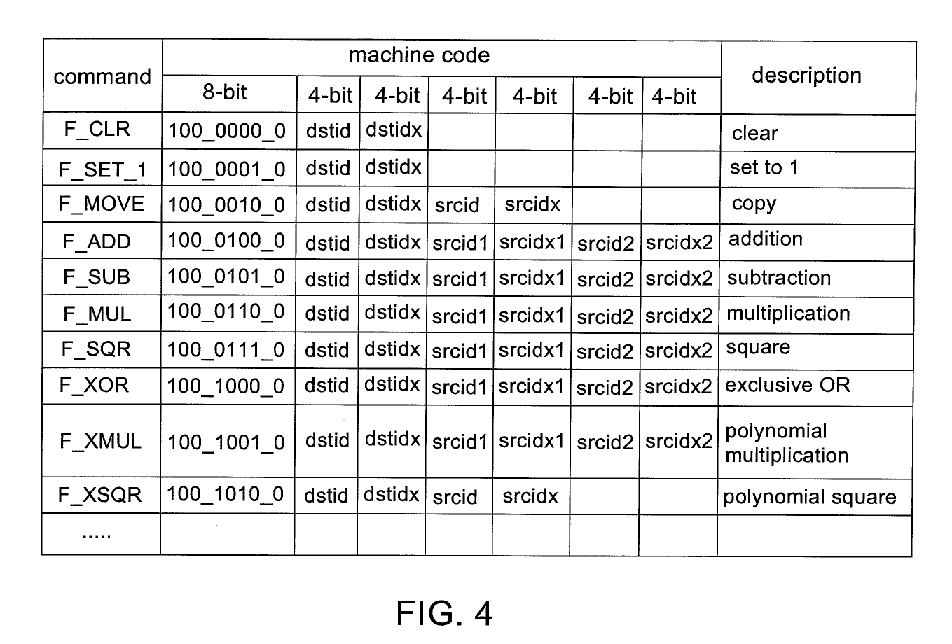

FIG. 4 is an exemplary EC instruction set according to an embodiment of the invention. Referring to FIG. 4, each EC instruction includes an opcode field and zero or more operand specifier fields. The opcode specifies an operation to perform while the operand specifier specifies a memory location in the field variable memory 220. Each operand specifier field includes a register-id (e.g., dstid, srcid, srcid1 and srcid2 in FIG. 4) sub-field and an index (e.g., dstidx, srcidx, srcidx1 and srcidx2 in FIG. 4) sub-field. A combination of a register-id sub-field and an index sub-field refers to one operand. According to the invention, the operand is a memory value (contained in the field variable memory 220) which is fetched using equation (2). In the embodiment of FIG. 4, the EC instruction set has uniform fields for the opcodes (8-bit) and the operand specifiers (8-bit); besides, the size or length of an EC instruction varies depending on different operations. It is noted that the EC instruction set of FIG. 4 is provided by example and not the limitations of the invention. The types of operations and the sizes (or lengths) of the opcode fields and the operand specifier fields can be adjusted depending on different needs. The types of operations may include point arithmetic, field arithmetic, logical operations, and program control, as well as scalar arithmetic. A feature of the EC instruction set is that each operand specifier in the EC instructions is encoded using the parameters regid and index based on equation (2). Due to equation (2), the instruction set of the invention is suitable for different bit-length EC standards.

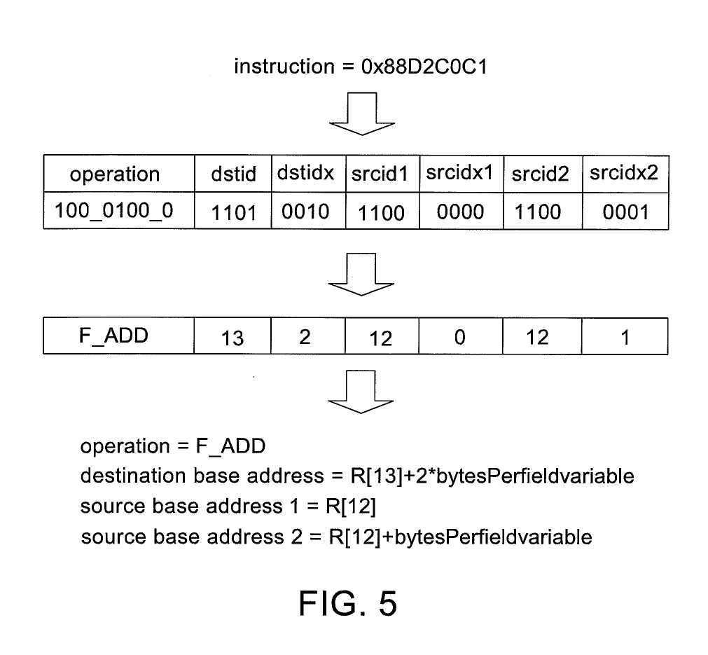

FIG. 5 is an exemplary EC instruction decoded in the EC processor. Assuming that the working registers R[0]˜R[15] (213a, 213b) are set to different base addresses via the field variable interface 270 and the configuration register (230a, 230b) is set to a predefined bit length in advance. Referring now to FIGS. 2A, 4 and 5, a decoded EC instruction is equal to 0x88D2C0C1 after an encoded instruction is fetched from the instruction memory 240 and decoded by the instruction decoder 214. According to the decoded instruction and equation (2), its operation (0x88) refers to an addition operation; its destination operand refers to a memory value stored in a memory location of (R[13]+2*bytesPerfieldvariable) because dstid=13 and dstidx=2; its first source operand refers to a memory value stored in a memory location of R[12] because srcid1=12 and srcidx1=0; its second source operand refers to a memory value stored in a memory location of (R[12]+bytesPerfieldvariable) because srcid2=12 and srcidx2=1.

Please be noted that the instruction memory 240 can be replaced with a computer-readable device or media. For example, the computer-readable media can include but are not limited to magnetic storage devices (such as hard disk, floppy disk, magnetic strips . . . ), optical disks (such as compact disk (CD), digital versatile disk (DVD) . . . ), smart cards, and flash memory device (such as card, stick).

Although the above embodiments are described herein in terms of Elliptic Curve cryptosystem, it should be understood that the above embodiments are not so limited, but are generally applicable to the use of any type of cryptosystems (or cipher systems) that may include a RSA cryptosystem, an Advance Encryption Standard (AES) cryptosystem, a Data Encryption Standard (DES) cryptosystem and a Secure Hash Algorithm (SHA) cryptosystem, and the like.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method of accessing a desired memory location applied in a cipher processing apparatus, wherein the cipher processing apparatus comprising a plurality of registers and a register storage, the method comprising:
reading a cipher instruction comprising an opcode field and an operand specifier field, wherein the operand specifier field comprises a register-id sub-field and an index sub-field;
reading a base address from one of the plurality of registers according to the register-id sub-field;
respectively reading a bit length and an index value from the register storage and the index sub-field;
determining the desired memory location according to the base address, the bit length and the index value; and
accessing the desired memory location to obtain a desired field variable.

2. The method according to claim 1, wherein the desired memory location is in a memory space of a memory device of the cipher processing apparatus.

3. The method according to claim 1, wherein the step of determining comprises:
determining the desired memory location according to an address equation;
wherein the address equation is given by:
field variable address=base address+index*bytesPerfieldvariable,
where field variable address denotes the desired memory location, index denotes the index value and bytesPerfieldvariable denotes the bit length.

4. The method according to claim 1, wherein the cipher instruction is associated with one of a point arithmetic operation, a field arithmetic operation and a scalar arithmetic operation.

5. The method according to claim 1, wherein a content of the register storage is varied according to a bit length of the desired field variable.

6. The method according to claim 1, wherein the cipher processing apparatus is an elliptic curve cryptography (EC) processing apparatus and the cipher instruction is an EC instruction.

7. The method according to claim 1, wherein the cipher processing apparatus is a RSA processing apparatus and the cipher instruction is a RSA instruction.

8. A machine-readable medium having stored thereon cipher instructions, which when executed by a cipher processor having a plurality of working registers, cause the cipher processor to implement the steps comprising:
decoding one cipher instruction comprising an opcode field and an operand specifier field, wherein the operand specifier field comprises a register-id sub-field and an index sub-field;
reading a base address from one of the plurality of working registers specified by the register-id sub-field;
respectively reading a bit length and an index value from a register storage and the index sub-field;
determining a field variable address according to the base address, the bit length and the index value;
reading a desired field variable from an external memory device according to the field variable address; and
performing an operation specified by the opcode field on the desired field variable.

9. The machine-readable medium according to claim 8, wherein the register storage is an external storage with respect to the cipher processor.

10. The machine-readable medium according to claim 8, wherein the register storage is integrated into the plurality of working registers.

11. The machine-readable medium according to claim 8, wherein the step of determining comprises:
determining the field variable address according to an address equation;
and wherein the address equation is given by:
field variable address=base address+index*bytesPerfieldvariable,
where index denotes the content of the index sub-field and bytesPerfieldvariable denotes the bit length.

12. The machine-readable medium according to claim 8, wherein the cipher processor is an elliptic curve cryptography (EC) processor and the cipher instructions are EC instructions.

13. The machine-readable medium according to claim 12, wherein each of the EC instructions is associated with one of a point arithmetic operation, a field arithmetic operation and a scalar arithmetic operation.

14. The machine-readable medium according to claim 8, wherein a content of the register storage is varied according to a bit length of the desired field variable.

15. The machine-readable medium according to claim 8, wherein the cipher processor is a RSA processor and the cipher instructions are RSA instructions.

16. A cipher processing apparatus, comprising:
a field variable memory for storing a plurality of field variables;
a register storage for storing a bit length of the plurality of field variables;
a memory device for storing cipher instructions; and
a cipher processor coupled between the instruction memory and the field variable memory, comprising;
an instruction decoder for decoding the cipher instructions, each including an opcode field and an operand specifier field, wherein the operand specifier field comprises a register-id sub-field and an index sub-field;
a plurality of working registers; and
an execution unit for receiving a decoded instruction from the instruction decoder, reading a desired field variable from the field variable memory according to a field variable address and performing an operation specified by the opcode field on the desired field variable;
wherein the execution unit obtains the field variable address according to a base address, the index sub-field and the bit length; and
wherein the register-id sub-field identifies a selected working register containing the base address.

17. The apparatus according to claim 16, wherein the register storage is an external storage with respect to the cipher processor.

18. The apparatus according to claim 16, wherein the register storage is integrated into the plurality of working registers.

19. The apparatus according to claim 16, wherein the execution unit obtains the field variable address according to an address equation;
and wherein the address equation is given by:
field variable address=base address+index*bytesPerfieldvariable,
where index denotes the content of the index sub-field and bytesPerfieldvariable denotes the bit length.

20. The apparatus according to claim 16, wherein each of the cipher instructions is associated with one of a point arithmetic operation, a field arithmetic operation and a scalar arithmetic operation.

21. The apparatus according to claim 16, wherein the cipher processor is an elliptic curve cryptography (EC) processor and the cipher instructions are EC instructions.

22. The apparatus according to claim 16, wherein the cipher processor is a RSA processor and the cipher instructions are RSA instructions.
